(19) United States
(12) Patent Application Publication
(10) Pub. No.: US 2018/0246697 A1
(43) Pub. Date: Aug. 30, 2018

(54) ELECTRONIC DEVICE AND METHOD FOR EXECUTING MUSIC-RELATED APPLICATION

(71) Applicant: Samsung Electronics Co., Ltd., Gyeonggi-do (KR)

(72) Inventors: Minhee LEE, Seoul (KR); Sungmin KIM, Seoul (KR); Hangyul KIM, Seoul (KR); Yunjae LEE, Seoul (KR); Youngeun KIM, Daegu (KR)

(73) Assignee: Samsung Electronics Co., Ltd.

(21) Appl. No.: 15/905,194

(22) Filed: Feb. 26, 2018

(30) Foreign Application Priority Data
Feb. 24, 2017 (KR) 10-2017-0024979

(51) Int. Cl. G06F 3/16; G06F 3/0482; G06F 3/0484; G06F 3/0488

(52) U.S. Cl. CPC G06F 3/165; G06F 3/04883; G06F 3/0484; G06F 3/0482

(57) ABSTRACT

Provided are an electronic device and method thereof for executing a music-related application and supporting music composition by readily generating melody data including the main melody of music based on a drawing input from the user.

### PRIORITY

This application claims priority under 35 U.S.C. § 119(a) to a Korean Patent Application filed in the Korean Intellectual Property Office on Feb. 24, 2017 and assigned Serial Number 10-2017-0024979, the contents of which are incorporated herein by reference.

### BACKGROUND

### 1. Field of the Disclosure

Embodiments of the present disclosure generally relate to an electronic device and operation method for executing a music-related application.

### 2. Description of the Related Art

Various electronic devices such as a smartphone, tablet personal computer (PC), portable multimedia player (PMP), personal digital assistant (PDA), laptop PC, and wearable device have increased in popularity.

Thus, techniques and applications have been developed that enable users to compose pieces of music using electronic devices.

Such a composition support application can display musical instruments constituting a piece of music to generate sounds corresponding respectively to the individual musical instruments. The user may generate sounds by playing the displayed musical instruments, and the generated sounds may be combined together to constitute one piece of music. However, if the accompaniment provided by the composition support application and the melody composed by the user are not synchronized, the completeness and correctness of the music composition is decreased.

In addition, a user who does not know how to play an instrument cannot readily use a conventional composition support application.

As such, there is a need in the art for a simplified and more user-friendly method and apparatus for composing music in an electronic device.

### SUMMARY

Aspects of the present disclosure are to address at least the above mentioned problems and/or disadvantages and to provide at least the advantages described below. Accordingly, an aspect of the present disclosure is to provide an electronic device and method for operating the same that support music composition based on drawing input from the user.

Another aspect of the present disclosure is to provide an electronic device and method for operating the same that support music composition by readily generating melody data including the main melody of music based on drawing input from the user.

Another aspect of the present disclosure is to provide an electronic device and method for operating the same that support music composition by generating the melody so that the pitch of the accompaniment is similar to that of the main melody by applying the chord of the music package selected by the user to the melody source corresponding to the drawing input from the user, thus enabling high-quality music composition.

In accordance with an aspect of the present disclosure, there is provided an electronic device capable of generating an audio file, including a display, and a processor configured to control the display to display a genre selection screen from which one or more genres of music is selected, control, in response to a user input for selecting at least one of the genres, the display to display an attribute selection screen from which attributes corresponding to the selected genre are selected, control the display to display a list of music packages corresponding to the selected genre and selected attribute, and generate, in response to a user input for selecting one of the music packages included in the list, the audio file by combining a first audio corresponding to the selected music package with a second audio generated based on a user gesture input.

In accordance with another aspect of the present disclosure, there is provided an electronic device including a display, and a processor configured to control the display to display a genre selection screen from which one or more genres of music is selected, control, in response to a user input for selecting at least one of the genres, the display to display an attribute selection screen from which attributes corresponding to the selected genre are selected, control the display to display a list of music packages corresponding to the selected genre and selected attribute, and control, in response to a user input for selecting one of the music packages included in the list, reproduction of a first audio corresponding to the selected music package.

In accordance with another aspect of the present disclosure, there is provided a method for operating an electronic device, including displaying a genre selection screen from which one or more genres of music is selected, displaying, in response to a user input for selecting at least one of the genres, an attribute selection screen from which attributes corresponding to the selected genre are selected, identifying at least one attribute selected by a user from the displayed attributes, displaying a list of music packages corresponding to the selected genre and selected attribute, and generating, in response to a user input for selecting one of the music packages included in the list, an audio file by combining a first audio corresponding to the selected music package with a second audio generated based on the user gesture input.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device in a network environment according to embodiments of the present disclosure;

FIG. 2 is a block diagram of an electronic device according to embodiments of the present disclosure;

FIG. 3 is a block diagram of a program module in an electronic device according to embodiments of the present disclosure;

FIG. 4 is a block diagram of an electronic device according to embodiments of the present disclosure;

FIG. 5 illustrates a procedure of the electronic device for generating an audio file according to embodiments of the present disclosure;

FIGS. 6A to 6D illustrate drawing input and melody modulation based on the input in the electronic device according to embodiments of the present disclosure;

FIGS. 7A, 7B, 7C, 7D and 7E are screen representations depicting music package selection in the electronic device according to embodiments of the present disclosure;

FIG. 8 is a flowchart illustrating a method of the electronic device according to embodiments of the present disclosure;

FIG. 9 is a flowchart illustrating accompaniment generation in the method of the electronic device according to embodiments of the present disclosure; and

FIG. 10 is a flowchart illustrating melody generation based on user gesture input in the method of the electronic device according to embodiments of the present disclosure.

### DETAILED DESCRIPTION

The following detailed description is made with reference to the accompanying drawings and is provided to assist in understanding the present disclosure. Various details are provided to assist in that understanding, but these are to be regarded as merely examples. Accordingly, those of ordinary skill in the art will recognize that various changes and modifications of the various embodiments described herein may be made without departing from the scope and spirit of the present disclosure. In addition, descriptions of well-known functions and constructions may be omitted for the sake of clarity and conciseness.

The terms used in the following detailed description and claims are not limited to their dictionary meanings, but are used to enable a clear and consistent understanding of the present disclosure. Accordingly, it is intended that the following description of embodiments of the present disclosure is provided for illustration purposes only and not for the purpose of limiting the present disclosure.

It is intended that the singular terms “a,” “an,” and “the” include plural referents unless the context clearly dictates otherwise. Thus reference to “a component surface” includes reference to one or more of such surfaces.

The term “substantially” may generally refer to a recited characteristic, parameter, or value that need not be achieved exactly, but that deviations or variations, such as tolerances, measurement error, and measurement accuracy limitations known to those of ordinary skill in the art, may occur in amounts that do not preclude the effect the characteristic was intended to provide.

The expressions “include” and “may include” which may be used in the present disclosure may refer to the presence of disclosed functions, operations, and elements but are not intended to limit one or more additional functions, operations, and elements. In the present disclosure, the terms “include” and/or “have” may be understood to refer to a certain characteristic, number, operation, element, component or a combination thereof, but are not intended to be construed to exclude the existence of or a possibility of addition of one or more other characteristics, numbers, operations, elements, components or combinations thereof.

Furthermore, in the present disclosure, the expression “and/or” includes any and all combinations of the associated listed words. For example, the expression “A and/or B” may include A, B, or both A and B.

In an embodiment of the present disclosure, expressions including ordinal numbers, such as “first” and “second,” and the like, may modify various elements. However, such elements are not limited by the above expressions. For example, the above expressions do not limit the sequence and/or importance of the elements. The above expressions are used merely to distinguish an element from other elements. For example, a first user device and a second user device may indicate different user devices, but both of them are user devices. For example, a first element may be referred to as a second element, and similarly, a second element may be also be referred to as a first element without departing from the scope of the present disclosure.

In a case where a component is referred to as being “connected” to or “accessed” by another component, it is intended that not only the component is directly connected to or accessed by the other component, but also there may exist another component between them. In addition, in a case where a component is referred to as being “directly connected” to or “directly accessed” by another component, it is intended that there is no component therebetween.

An electronic device according to the present disclosure may be a device including a communication function. For example, and without limitation, the device may correspond to a combination of at least one of a smartphone, a tablet personal computer (PC), a mobile phone, a video phone, an electronic-book (e-book) reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, home appliances (for example, an air-conditioner, a vacuum, an oven, a microwave, a washing machine, an air cleaner, and the like), an artificial intelligence robot, a television (TV), a digital versatile disc (DVD) player, an audio device, various medical devices (for example, a magnetic resonance angiography (MRA) device, a magnetic resonance imaging (MRI) device, a computed tomography (CT) device, a scanning machine, an ultrasonic wave device, and the like), a navigation device, a global positioning system (GPS) a receiver, an event data recorder (EDR), a flight data recorder (FDR), a set-top box, a TV box (for example, Samsung HomeSync®, Apple TV®, or Google TV™), an electronic dictionary, vehicle infotainment device, an electronic equipment for a ship (for example, navigation equipment for a ship, gyrocompass, and the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, or the like. It will be apparent to those skilled in the art that an electronic device according to the present disclosure is not limited to the aforementioned devices.

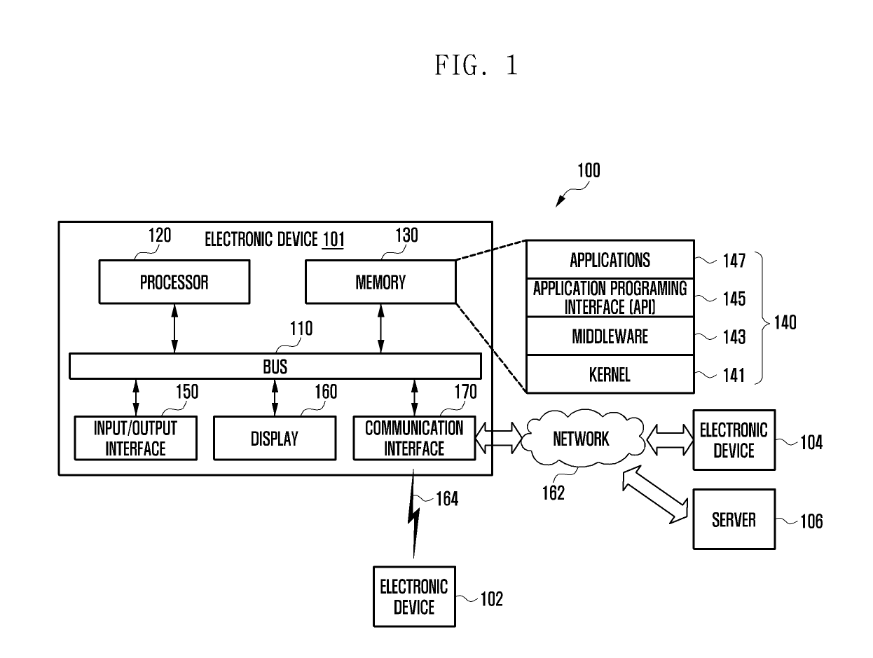

FIG. 1 is a block diagram of an electronic device 101 in a network environment 100 according to an embodiment of the present disclosure.

Referring to FIG. 1, the electronic device 101 may include a bus 110, a processor including processing circuitry 120, a memory 130, an input/output interface including interface circuitry 150, a display 160, a communication interface including communication circuitry 170, and other similar and/or suitable components.

The bus 110 may be a circuit which interconnects the above-described elements and delivers a communication, such as a control message, between the above-described elements.

The processor 120 may include various processing circuitry and receive commands from the above-described other elements, such as the memory 130, the input/output interface 150, the display 160, and the communication interface 170, through the bus 110, interpret the received commands, and execute a calculation or process data according to the interpreted commands. Although illustrated as one element, the processor 120 may include multiple processors and/or cores without departing from the scope and spirit of the present disclosure. The processor 120 may include various processing circuitry, including a microprocessor or any suitable type of processing circuitry, including but not limited to one or more central processing units (CPUs), general-purpose processors, such as advanced reduced instruction set (RISC) machine (ARM)-based processors, a digital signal processor (DSP), a programmable logic device (PLD), an application-specific integrated circuit (ASIC), a field-programmable gate array (FPGA), a graphics processing unit (GPU), and a video card controller. Any of the functions and steps provided in the accompanying drawings may be implemented in hardware, software or a combination of both and may be performed in entirety or in part within the programmed instructions of a computer. In addition, one of ordinary skill in the art will understand that a processor or a microprocessor may be hardware in the present disclosure.

The memory 130 may store commands or data received from or generated by the processor 120 or the other elements, and may include programming modules 140, such as a kernel 141, middleware 143, an application programming interface (API) 145, and applications 147. Each of the above-described programming modules may be implemented in software, firmware, hardware, or a combination of two or more thereof.

The kernel 141 may control or manage system resources used to execute operations or functions implemented by other programming modules, and may provide an interface capable of accessing and controlling or managing the individual elements of the electronic device 101 by using the middleware 143, the API 145, or the applications 147.

The middleware 143 may link the API 145 or the applications 147 and the kernel 141 in such a manner that the API 145 or at least one of the applications 147 communicates with the kernel 141 and exchanges data therewith, and in relation to work requests received from the applications 147 and/or the middleware 143 may perform load balancing of the work requests by using a method of assigning a priority, in which system resources of the electronic device 101 can be used, to the applications 147.

The API 145 is an interface through which at least one of the applications 147 is capable of controlling a function provided by the kernel 141 or the middleware 143, and may include at least one interface or function for file, window, image processing, or character control, for example.

The input/output interface 150 may include various interface circuitry, may receive a command or data as input from a user, and may deliver the received command or data to the processor 120 or the memory 130 through the bus 110. The display 160 may display a video, an image, and data, to the user.

The communication interface 170 may include various communication circuitry and connect communication between electronic devices 102 and 104 and the electronic device 101, and may support a short-range communication protocol, such as wireless fidelity (Wi-Fi), Bluetooth (BT), and near field communication (NFC), or a network communication, such as the Internet, a local area network (LAN), a wide area network (WAN), a telecommunication network, a cellular network, a satellite network, or a plain old telephone service (POTS). Each of the electronic devices 102 and 104 may be identical to or different from the electronic device 101 in type. The communication interface 170 may enable communication between a server 106 and the electronic device 101 via a network 162, and may establish a short-range wireless communication connection 164 between the electronic device 101 and any other electronic device.

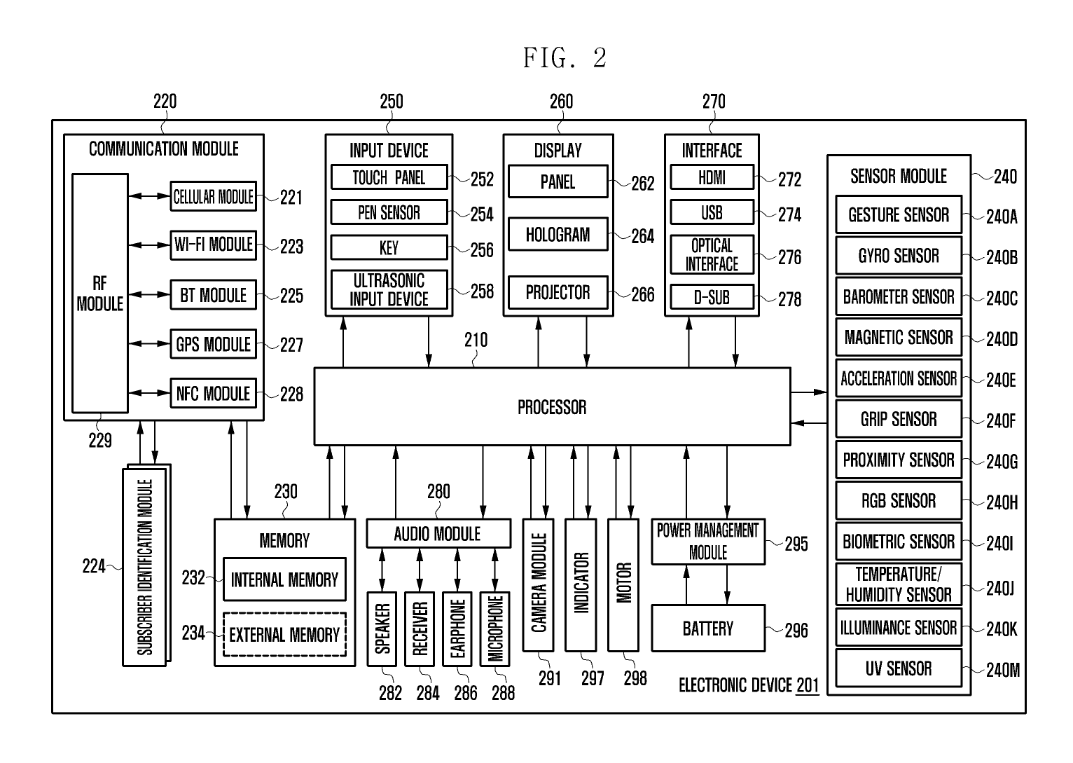

FIG. 2 is a block diagram of an electronic device 201 according to an embodiment of the present disclosure.

Referring to FIG. 2, the electronic device 201 may include an application processor (AP) including processing circuitry 210, a subscriber identification module (SIM) card 224, a memory 230, a communication module including communication circuitry) 220, a sensor module 240, an input device including input circuitry 250, a display 260, an interface including interface circuitry 270, an audio module including a coder/decoder (codec) 280, a camera module 291, a power management module 295, a battery 296, an indicator 297, a motor 298 and any other similar and/or suitable components.

The processor 210 may include various processing circuitry, such as one or more of a dedicated processor, a CPU, APs, and one or more communication processors (CPs). The AP and the CP may be included in the processor 210 in FIG. 2, or may be included in different integrated circuit (IC) packages, respectively, and may be included in one IC package.

The AP may execute an operating system (OS) or an application program, may thereby control multiple hardware or software elements connected to the AP, may perform processing of and arithmetic operations on various data including multimedia data, and may be implemented by a system on chip (SoC). The processor 210 may further include a GPU.

The CP may manage a data line and may convert a communication protocol in the case of communication between the electronic device including the electronic device 201 and different electronic devices connected to the electronic device through the network, may be implemented by an SoC, may perform at least some of multimedia control functions, may distinguish and authenticate a terminal in a communication network using the SIM 224, and may provide a user with services, such as a voice telephony call, a video telephony call, a text message, and packet data, and the like.

The CP may control the transmission and reception of data by the communication module 220. In FIG. 2, the elements are illustrated as elements separate from the processor 210, but the processor 210 may include at least some of the above-described elements. The AP or the CP may load, to a volatile memory, a command or data received from at least one of a non-volatile memory and other elements connected to each of the AP and the CP, may process the loaded command or data, and may store, in a non-volatile memory, data received from or generated by at least one of the other elements.

The SIM 224 may be a card implementing a SIM, may be inserted into a slot formed in a particular portion of the electronic device 201, and may include unique identification information, such as IC card identifier (ICCID) or subscriber information, such as international mobile subscriber identity (IMSI).

The memory 230 may include an internal memory 232 and/or an external memory 234. The internal memory 232 may include at least one of a volatile memory, such as a dynamic random access memory (DRAM), a static RAM (SRAM), and a synchronous dynamic RAM (SDRAM), and a non-volatile memory, such as a one-time programmable read only memory (OTPROM), a programmable ROM (PROM), an erasable and programmable ROM (EPROM), an electrically erasable and programmable ROM (EEPROM), a mask ROM, a flash ROM, a NOT AND (NAND) flash memory, and a NOT OR (NOR) flash memory. The internal memory 232 may be as a solid state drive (SSD). The external memory 234 may further include a flash drive a compact flash (CF) drive, a secure digital (SD) drive, a micro-SD drive, a mini-SD drive, an extreme digital (xD) drive, or a memory stick, for example.

The communication module 220 may include various communication circuitry, including but not limited to a radio frequency (RF) module 229, may further include various communication circuitry, such as wireless communication modules, to enable wireless communication through the RF module 229. The wireless communication modules may include, but not be limited to, a cellular module 221, a wireless fidelity (Wi-Fi) module 223, a Bluetooth® (BT) module 225, a global positioning system (GPS) module 227, and an NFC module 228. Additionally or alternatively, the wireless communication modules may further include a network interface, such as a local area network (LAN) card, or a modulator/demodulator (modem), for connecting the electronic device 201 to a network.

The communication module 220 may perform data communication with the electronic devices 102 and 104, and the server 106 through the network 162. The RF module 229 may be used for transmission and reception of data, such as RF or electronic signals, may include a transceiver, a power amplifier module (PAM), a frequency filter, or a low noise amplifier (LNA), and may further include a component for transmitting and receiving electromagnetic waves in free space in a wireless communication such as a conductor or a conductive wire.

The sensor module 240 may include at least one of a gesture sensor 240A, a gyro sensor 240B, an barometer, such as atmospheric pressure) sensor 240C, a magnetic sensor 240D, an acceleration sensor 240E, a grip sensor 240F, a proximity sensor 240G, a red, green and blue (RGB) sensor 240H, a biometric (bio) sensor 240I, a temperature/humidity sensor 240J, an illumination sensor 240K, and an ultra violet (UV) light sensor 240M. The sensor module 240 may measure a physical quantity or detect an operating state of the electronic device 201, convert the measured or detected information into an electrical signal, and further include an electronic nose (E-nose) sensor, an electromyography (EMG) sensor, an electroencephalogram (EEG) sensor, an electrocardiogram (ECG) sensor, a fingerprint sensor, and a control circuit for controlling one or more sensors included therein. The sensor module 240 may be controlled by the processor 210.

The input device 250 may include various input circuitry, such as a touch panel 252, a pen sensor 254, a key 256, and an ultrasonic input device 258. The touch panel 252 may recognize a touch input in at least one of a capacitive, resistive, infrared, and acoustic wave scheme, and may further include a controller. In the capacitive type, the touch panel 252 is capable of recognizing a proximity touch as well as a direct touch. The touch panel 252 may further include a tactile layer that may provide a tactile response to a user.

The pen sensor 254 may be implemented by using a method identical or similar to a method of receiving a touch input from a user, or by using a separate sheet for recognition. For example, a key pad or a touch key may be used as the key 256. The ultrasonic input device 258 enables the electronic device 201 to detect a sound wave by using a microphone 288 of the electronic device 201 through a pen generating an ultrasonic signal, and identify data, and is capable of wireless recognition. The electronic device 201 may receive a user input from an external device, such as a network, a computer, or a server, which is connected to the electronic device 201, through the communication module 220.

The display 260 may include a panel 262, a hologram 264, and a projector 266. The panel 262 may be a liquid crystal display (LCD) and an active matrix organic light emitting diode (AM-OLED) display, but is not limited thereto, may be implemented so as to be flexible, transparent, or wearable, and may include the touch panel 252 and one module. The hologram 264 may display a three-dimensional image in the air by using interference of light. The projector 266 may include light-projecting elements, such as LEDs, to project light onto external surfaces. The display 260 may further include a control circuit for controlling the panel 262, the hologram 264, or the projector 266.

The interface 270 may include various interface circuitry, such as a high-definition multimedia interface (HDMI) 272, a universal serial bus (USB) 274, an optical interface 276, and a d-subminiature (D-sub) connector 278, and may include an SD/multi-media card (MMC) or an interface according to a standard of the Infrared Data Association (IrDA).

The audio module 280 may include a codec and may bidirectionally convert between an audio signal and an electrical signal. The audio module 280 may convert voice information, which is input to or output from the audio module 280 through a speaker 282, a receiver 284, an earphone 286, or the microphone 288, for example.

The camera module 291 may capture a still image and a moving image, and may include one or more image sensors, such as a front lens or a back lens, an image signal processor (ISP), and a flash LED.

The power management module 295 may manage power of the electronic device 201, may include a power management IC (PMIC), a charger IC, or a battery gauge, and may be mounted to an IC or an SoC semiconductor. Charging methods may be classified into wired and wireless charging methods. A charger IC may charge a battery, and prevent an overvoltage or an overcurrent between a charger and the battery, and may provide at least one of a wired charging method and a wireless charging method. Examples of a wireless charging method may include magnetic resonance, magnetic induction, and electromagnetic methods, and additional circuits, such as a coil loop, a resonance circuit, or a rectifier for wireless charging may be added in order to perform wireless charging.

The battery gauge may measure a residual quantity of the battery 296, a voltage, a current or a temperature during charging, may supply power by generating electricity, and may be a rechargeable battery.

The indicator 297 may indicate particular states of the electronic device 201 or a part of the electronic device 201, such as a booting, message, or charging state. The motor 298 may convert an electrical signal into a mechanical vibration.

The electronic device 201 may include a processing unit, such as a GPU, for supporting a module TV, which unit may process media data according to standards, such as digital multimedia broadcasting (DMB), digital video broadcasting (DVB), and MediaFlow®.

Each of the above-described elements of the electronic device 201 may include one or more components, and the names of the elements may change depending on the type of the electronic device 201, which may include at least one of the above-described elements. Some of the above-described elements may be omitted from the electronic device 201, additional elements may be added, and some of the elements may be combined into one entity, which may perform functions identical to those of the relevant elements before the combination.

The term “module” used in the present disclosure may refer to a unit including one or more combinations of hardware, software, and firmware, may be interchangeably used with the terms “unit,” “logic,” “logical block,” “component,” or “circuit,”, for example, may indicate a minimum unit of a component formed as one body or a part thereof, a minimum unit for performing one or more functions or a part thereof, a unit that is implemented mechanically or electronically, and a unit that includes at least one of a dedicated processor, a CPU, an ASIC, an FPGA, and a programmable-logic device for performing certain operations which are known or will be developed in the future.

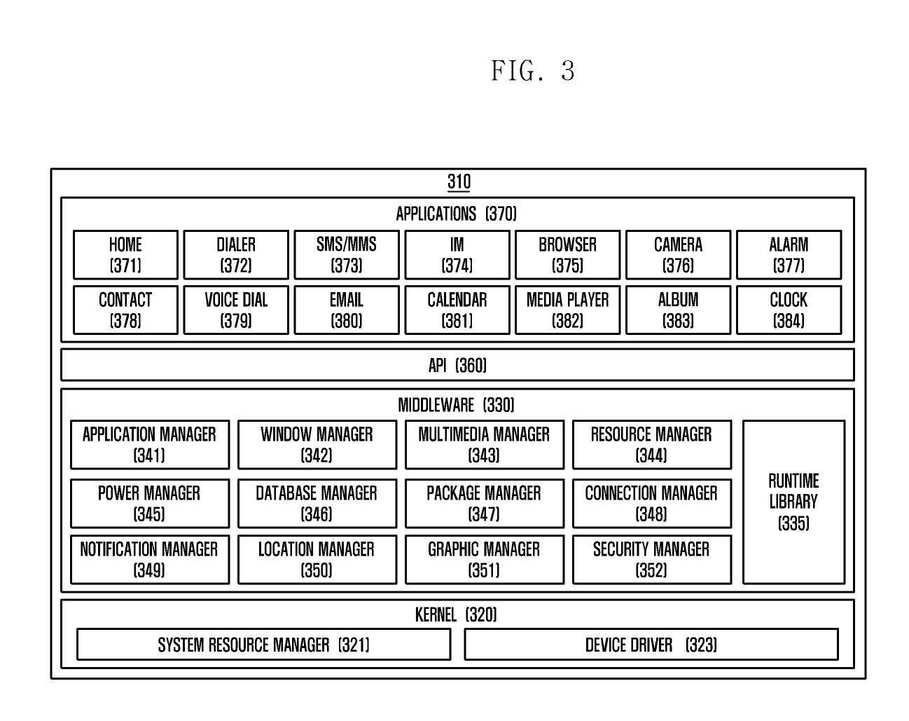

FIG. 3 is a block diagram of a programming module 310 according to an embodiment of the present disclosure.

Referring to FIG. 3, at least a part of the programming module 310 may be implemented in software, firmware, hardware, or a combination of two or more thereof. The programming module 310 may be implemented in hardware, and may include an OS controlling resources related to an electronic device and/or various applications 370 executed in the OS, which is for example, Android®, iOS®, Windows®, Symbian®, Tizen®, or Bada™.

The programming module 310 may include a kernel 320, middleware 330, an API 360, and/or applications 370. The kernel 320 may include a system resource manager 321 and/or a device driver 323. The system resource manager 321 may include a process manager, a memory manager, and a file system manager, and may perform control, allocation, and recovery of system resources. The device driver 323 may include a display driver, a camera driver, a BT driver, a shared memory driver, a USB driver, a keypad driver, a Wi-Fi driver, an audio driver, and an inter-process communication (IPC) driver.

The middleware 330 may include multiple modules previously implemented so as to provide a function used in common by the applications 370, and may provide a function to the applications 370 through the API 360 in order to enable the applications 370 to efficiently use limited system resources within an electronic device. For example, the middleware 330 may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, a security manager 352, and any other suitable and/or similar manager.

The runtime library 335 may include a library module used by a complier in order to add a new function by using a programming language during execution of the applications 370, and may perform functions which are related to input and output, the management of a memory, or an arithmetic function, for example.

The application manager 341 may manage a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as source code, a memory, and a storage space, of the applications 370.

The power manager 345 may operate with a basic input/output system (BIOS), manage a battery or power, and provide power information used for an operation. The database manager 346 may manage a database in such a manner as to enable the generation, search and/or change of a database to be used by the applications 370. The package manager 347 may manage the installation and/or update of an application distributed as a package file.

The connection manager 348 may manage wireless connectivity, such as Wi-Fi and BT. The notification manager 349 may display or report, to a user, an event, such as an arrival message, an appointment, a proximity alarm, and the like in such a manner as not to disturb the user. The location manager 350 may manage location information of an electronic device. The graphic manager 351 may manage a graphic effect which is to be provided to the user and/or a user interface related to the graphic effect. The security manager 352 may provide various security functions used for system security and user authentication, for example. When an electronic device has a telephone function, the middleware 330 may further include a telephony manager for managing a voice telephony call function and/or a video telephony call function of the electronic device.

The middleware 330 may generate and use a new middleware module through various functional combinations of the above-described internal modules, may provide modules specialized according to types of OSs in order to provide differentiated functions, may dynamically delete some of the existing elements, may add new elements, or may replace some of the elements with other elements, each of which performing a similar function but having a different name.

The API 360 is a set of API programming functions, and may be provided with a different configuration according to an OS. In the case of Android® or iOS® one API set may be provided to each platform. In the case of Tizen® two or more API sets may be provided to each platform.

The applications 370 may include a preloaded application and/or a third party application. The applications 370 may include a home 371, dialer 372, short message service (SMS)/multimedia message service (MMS) 373, instant message (IM) 374, browser 375, camera 376, alarm 377, contact 378, voice dial 379, electronic mail (e-mail) 380, calendar 381, media player 382, album 383, and clock 384 applications, and any other suitable and/or similar applications.

At least a part of the programming module 310 may be implemented by instructions stored in a non-transitory computer-readable storage medium. When the instructions are executed by one or more processors, the one or more processors may perform functions corresponding to the instructions. At least a part of the programming module 300 may be executed by the processor 210 and may include a module, a program, a routine, a set of instructions, and/or a process for performing one or more functions.

Names of the elements of the programming module 310 may change depending on the type of OS. The programming module according to an embodiment of the present disclosure may include one or more of the above-described elements, some of the above-described elements may be omitted from the programming module and additional elements may be added thereto. The operations performed by the programming module or other elements according to an embodiment of the present disclosure may be processed in a sequential, parallel, repetitive, or heuristic method, some of the operations may be omitted, or other operations may be added.

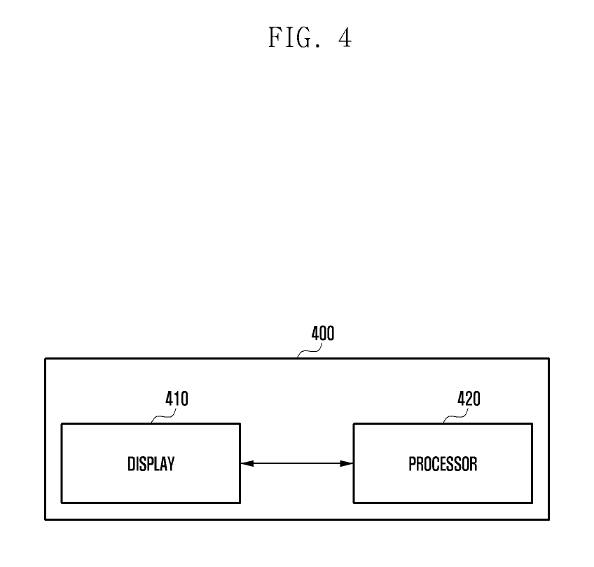

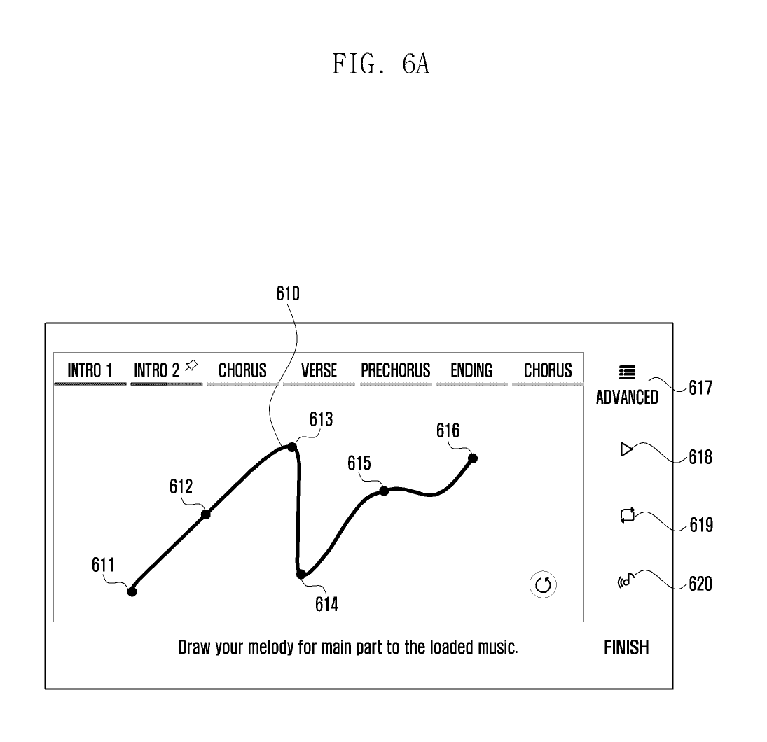

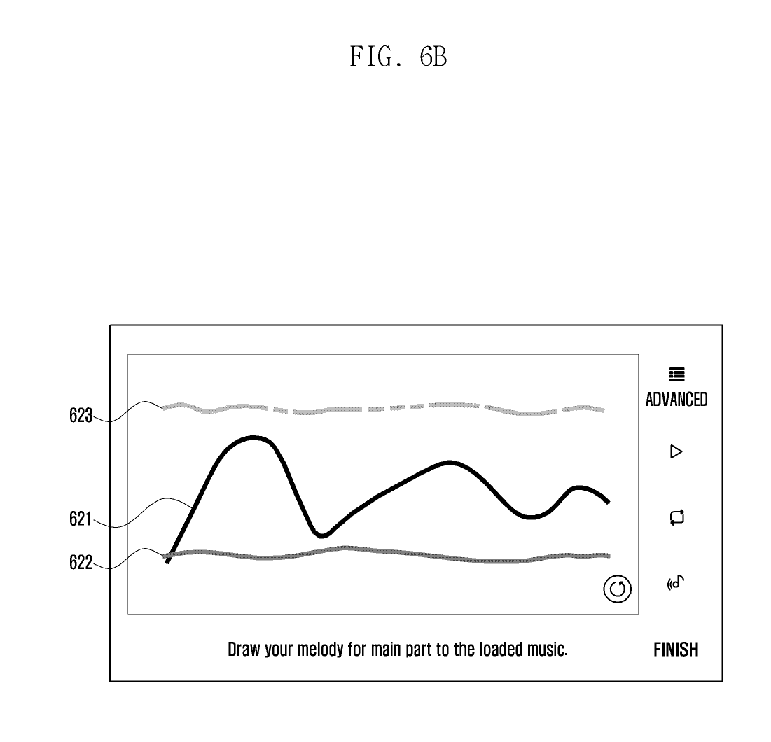

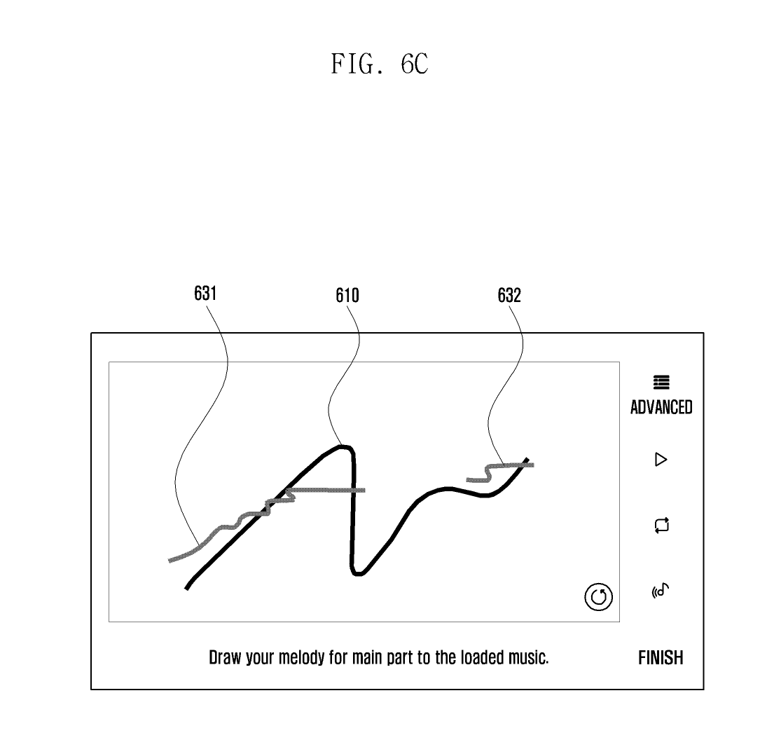

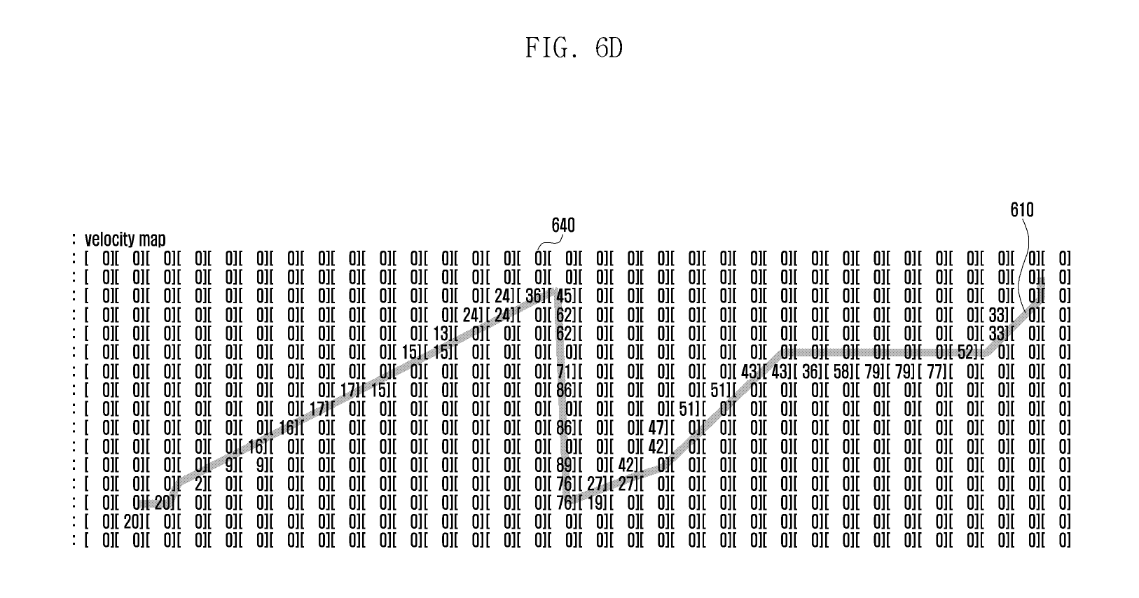

FIG. 4 is a block diagram of an electronic device according to embodiments of the present disclosure, and will be described in reference to FIGS. 6A, 6B, 6C and 6D where appropriate.

The electronic device 400 may include a display 410, a processor 420, and a sensor.

The display 410 may receive a gesture input from the user, such as a drawing input made by the user who draws a line or model using a user's hand or an input tool, such as a touch pen or mouse. For generating audio, the user may enter a drawing on the display 410. Audio generation will be described in detail in the description of the processor 420 below.

To receive a drawing input from the user, the display 410 may be implemented as a combination of a touch panel capable of receiving a drawing input and a display panel. To receive a drawing input using a pen, the display 410 may further include a panel capable of recognizing a pen touch. To recognize pressure caused by a drawing input, the display 410 may further include a panel implementing a pressure sensor.

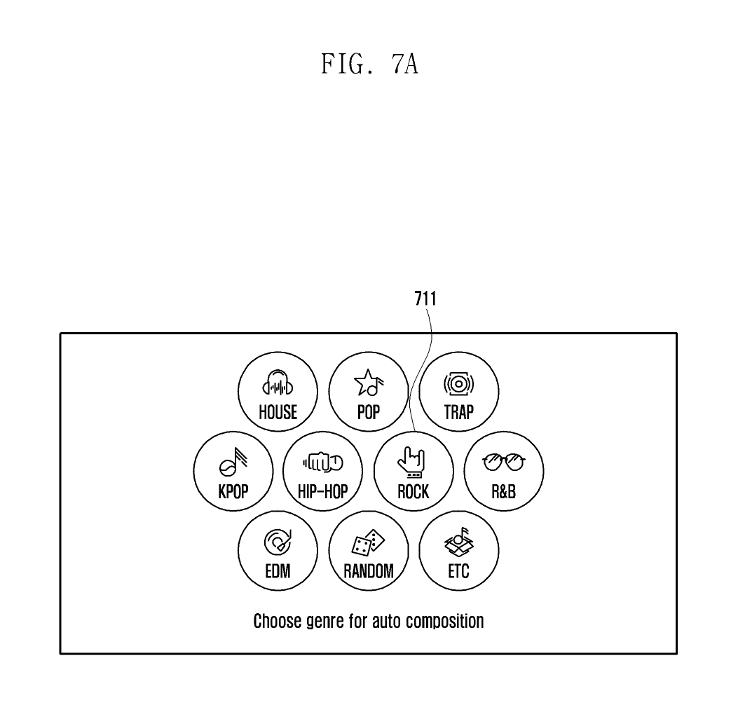

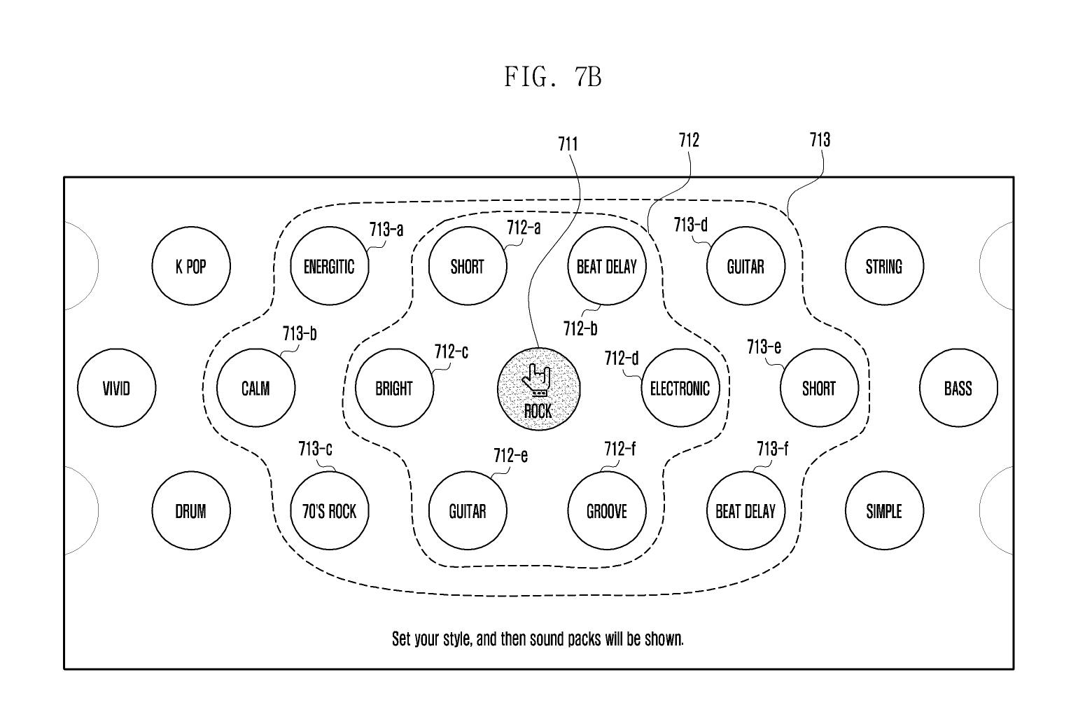

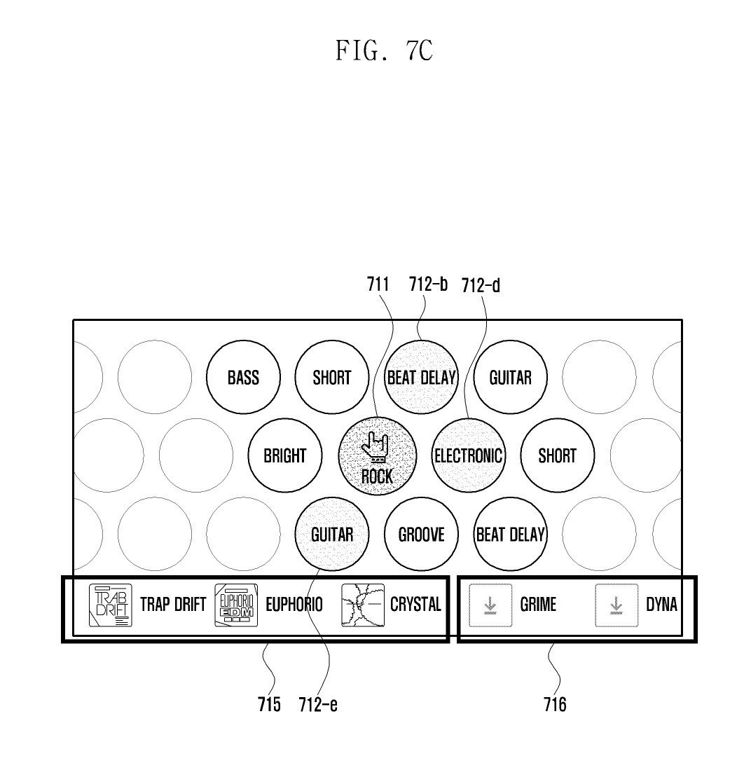

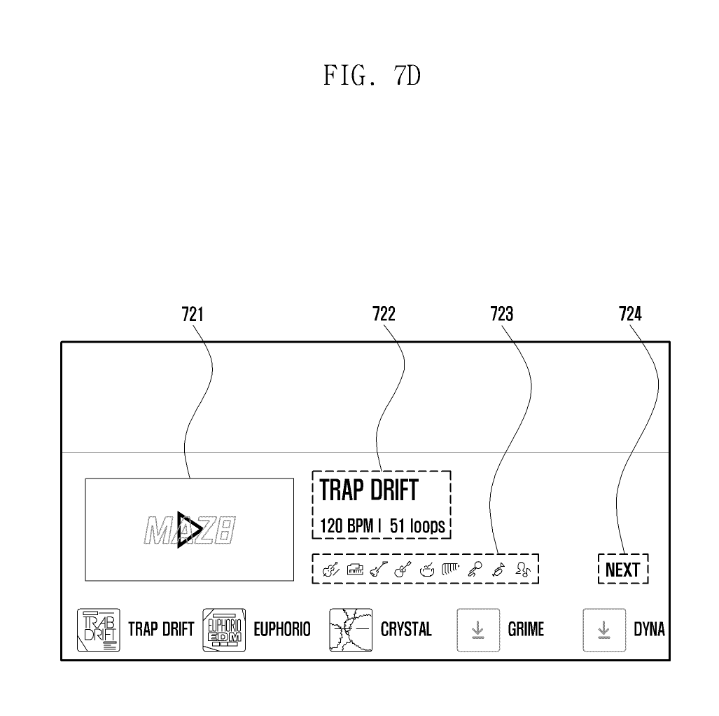

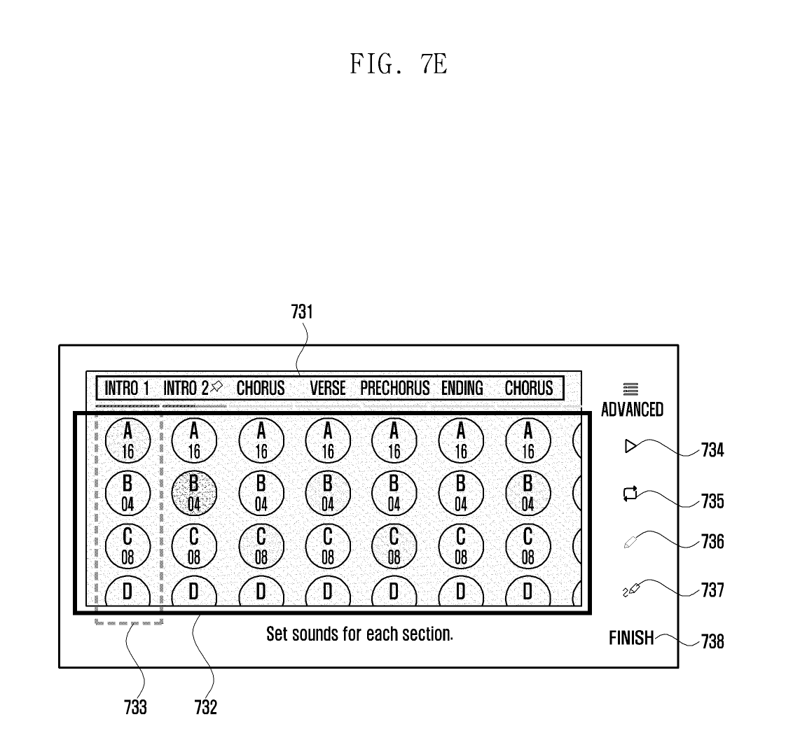

The display 410 may display a screen, described below in reference to FIGS. 7A, 7B and 7C, that enables the user to enter a drawing input and select a music package.

The electronic device 400 may further include a sensor that senses a gesture input from the user. In another embodiment, the sensor may be not separately implemented and may be incorporated into the display 410 so that the display 410 can receive a gesture input from the user.

The processor 420 may identify the characteristics of a music package in response to a user input for selecting the music package, which may include first audio used for audio generation, information on the types of musical instruments constituting the first audio, status information on the musical instruments, and a list of sections constituting the first audio. A section can indicate the largest unit of a piece of music. For example, one piece of music may include an introduction or a refrain, each of which may form a section. One section may include a plurality of phrases including a plurality of motifs. A motif may be the smallest meaningful unit of a piece of music. The electronic device can generate a single motif using a drawing input. The generated motif can be modified based on the characteristics of the drawing input and the music package, and the processor 420 may generate the main melody (second audio) of the music by using the generated and modified motifs, as described in detail below.

The user may enter a drawing input on the display 410, and the drawing input can be used as an input to produce a piece of music contained in an audio file in entirety or in sections. As described above, the display 410 can visually present a drawing input entered by the user.

The processor 420 may identify the characteristics of the first audio contained in the music package selected by the user and the characteristics of the drawing input.

The characteristics of the drawing input can be identified by using four layers including a canvas, motif, history, and area layer.

The canvas layer may store information on the drawings contained in the drawing input.

The motif layer may store information on the order in which drawings are input by the drawing input and the position of each drawing drawn on the canvas layer.

The history layer may store information regarding the order in which the lines included in each drawing are drawn, the speed at which each line is drawn, the position of each line drawn on the canvas layer, and the process by which each drawing is created.

The area layer may store information regarding the area of the canvas layer occupied by each drawing included in the drawing input, and point (or area) created by the intersection of the drawings included in the drawing input. While receiving a drawing input from the user, the processor 420 may generate the four layers to analyze the drawing input.

The processor 420 may identify the characteristics of the first audio included in the music package, which may be a file containing information needed by an audio file corresponding to the music composition and the composed music. In other words, the music package may contain first audio data corresponding to the audio of an audio file, data related to the characteristics of the first audio, and a tag associated with the characteristics of the first audio. The processor 420 may control the display 410 to display a screen enabling one or more tags to be selected. The user can select a tag from the tag selection screen including one or more tags displayed on the display 410, and generate an audio file using the music package corresponding to the selected tag, as will be described in detail with reference to FIGS. 7A, 7B and 7C.

For example, the characteristics of the first audio may include the types of sections, such as introduction or refrain, constituting the first audio, the characteristics of each section, such as length, tone, sound effects, and meter or beats per minute (bpm), the order of the sections, melody applicability to each section (a melody that can be generated by the drawing input of the user may be not applied to the introduction, but may be applied to the refrain), and chord scale information. A chord herein refers to at least two notes simultaneously played at the same time, and more frequently consists of at least three notes simultaneously played.

The chord scale corresponding to the first audio may refer to a group of candidate chords that can be applied to the second audio generated by the drawing input. A chord scale may be assigned to each section included in the first audio, and may include information regarding the progress, characteristics, and purpose of the chord, such as for brightening the mood of the song or for darkening the mood of the song, for example.

The processor 420 may generate the second audio by applying one of the chords included in a chord candidate group to the melody data generated by the drawing input. The second audio may indicate the main melody of the section, phrase, or motif to which the second audio is applied. The processor 420 may extract the motif based on the characteristics of the drawing input identified using the four layers. For example, the motif can be generated based on the order of the drawings contained in the motif layer among the four layers, and the positions of the drawings on the canvas layer. For example, FIG. 6A illustrates points 611 to 616 on a drawing 610 on the canvas layer, in which the y-axis value rises from the initial point 611 via point 612 to point 613, decreases sharply from point 613 to point 614, and increases from point 614 via point 615 to point 616. In this case, the motif generated by such a drawing may include information in which the pitch rises in the interval from point 611 to point 613 where the y-axis value increases, falls in the interval from point 613 to point 614, and rises again in the interval from point 614 to point 616. The motif may include information about changes in the pitch corresponding to the drawing input.

The processor 420 may identify the characteristics of the drawing input through the area layer among the four layers. For example, the processor 420 can identify the area of the canvas layer occupied by the drawings contained in the area layer.

The processor 420 can identify the characteristics of elements, such as lines, included in the drawing using the history layer among the four layers. For example, the processor 420 can check the process of making the drawing, the order of the lines included in the drawing, the position of the lines located on the motif layer, the slope (or velocity) of the lines, and the time taken to make the drawing. The processor 420 may modify the motif extracted from the motif layer based on the characteristic information of the elements included in the drawing input and drawing extracted from the area layer and/or the history layer.

The processor 420 may determine the length (or time) of the second audio to be generated (may be generated by the melody data) using the motif extracted from the motif layer, may determine the length of the melody data based on the characteristics of the first audio, and may develop the motif up to the determined length of the second audio. For example, when the length of the motif is 4 and the length of the second audio is 16, the processor 420 can generate melody data with a total length of 16 based on the first motif generated using the motif layer and the second motif generated by modulating the first motif using the history layer or the area layer.

The processor 420 may modify the motif based on the area of the drawing extracted from the area layer, and can determine the complexity of the motif modulation depending on the area of the drawing. As the complexity of the motif modulation increases, the degree of repetition of the motif may decrease, and as the complexity of the motif modulation decreases, the degree of repetition of similar motifs may increase. For example, the processor 420 may determine the complexity of the motif modulation in proportion to the area of the drawing.

The processor 420 may modify the motif by using velocity information of the lines included in the drawing extracted from the history layer in a manner changing the rhythm.

FIG. 6D illustrates a velocity table 640 of a drawing 610 on which drawing velocity is mapped. The processor 420 may use the velocity table 640 to extract the average velocity and the maximum velocity at which the drawing 610 is drawn. It can be seen from the velocity table 640 that velocity information for the portion corresponding to the drawing 610 is included in the velocity table 640. In one embodiment, the processor 420 may apply the delay effect among the sound effects to the portion corresponding to the motif 610 among the melody data based on the average velocity extracted from the velocity table 640, and may also apply sound effects that the sound is pushed to the portion corresponding to the motif 610 among the melody data based on the maximum velocity extracted from the velocity table.

For example, if the velocity at which the line is drawn exceeds a preset value, the motif can be modified using another rhythm. In another embodiment, if the velocity exceeds a preset value, the processor 420 may modify the rhythm corresponding to the motif. In addition, if the velocity is below a preset value, the processor 420 may modify the pitch corresponding to the motif.

The processor 420 can change the tone of the motif using the slope information of the line extracted from the history layer. The tone can indicate a sensory feature resulting from a difference between sound components, and can be changed by modifying the frequency of the sound. For example, the processor 420 may change the tone and modulate the motif while differently setting the sound frequency according to the slope of the line.

The processor 420 may change the pitch included in the motif based on the direction and length information of the line extracted from the history layer. The motif may include a relative difference between notes included in the motif. The processor 420 may modify the motif by adjusting the relative difference between the notes included in the motif based on the direction and length of the line. Pitch may indicate a degree of highness or lowness of the notes.

The processor 420 may modify the motif based on the order of drawing input extracted from the history layer. In FIG. 6B, it can be seen that the drawing input includes three lines. It is possible to determine which of the three lines included in the drawing input is most importantly used for motif modification in consideration of the input order of the lines. For example, the feature corresponding to the most recently drawn line 623 may be more frequently used to modify the motif than the feature corresponding to the other lines 621 and 622.

The processor 420 may modify the motif generated using the motif layer based on the three layers reflecting the characteristics of the drawing input. FIG. 6C illustrates a motif 610 created using the motif layer and modified motifs 631 and 632. The processor 420 may generate the modified motifs 631 and 632 in consideration of the characteristics of the motif 610. The modified motifs 631 and 632 can be used for phrase generation and section generation.

The processor 420 may combine modified and existing motifs (motif development) to generate a phrase, may combine the generated phrases to generate a section, and may combine the generated sections to generate one piece of melody data.

The processor 420 may extract the positions of the lines and the intersection components generated by intersecting lines from the area layer to add chords to the melody data.

Various techniques can be used for generating a phrase by modifying the pitch corresponding to the motif and developing the motif. Table 1 below describes techniques for motif development by using a motif modified through pitch modification.

TABLE 1

| Pitch modification | Modification technique |
|---|---|
| Repetition | Motif development by repeating |
| | the pitch |
| Inversion | Motif development by inverting |
| | the motif with respect to |
| | the median of pitches contained |
| | in the motif |
| Sequence | Change all the pitch values |
| | included in the motif |
| Transposition | Change the order of all of the |
| | pitches included in the motif |

Various techniques can be used for generating a phrase by modifying the rhythm corresponding to the motif and developing the motif. Table 2 below describes techniques for motif development by using a motif modified through rhythm modification.

TABLE 2

| Rhythm | |
|---|---|
| modification | Modification technique |
| Retrograde | Motif development by reversing the |
| | order of progression of the overall rhythm |
| Interversion | Reverse the rhythm shape with respect |
| | to the mid-time of the overall rhythm, |
| | such as rhythm “A + B” |
| | being changed to “B + A” |
| Augmentation | Increase the duration of the rhythm |
| Diminution | Reduce the duration of the rhythm |

The processor 420 may combine the generated phrases to create a section (section building). In various embodiments, a generated motif may be combined with a motif modified based on the characteristics of the drawings to generate a phrase, and the generated phrase may be combined with a modified phrase to build a section. Table 3 below describes some techniques for section building.

TABLE 3

| Section building | Modification |
|---|---|
| Symmetric | Technique usable for a section including |
| | an even number of phrases (implementable |
| | in ABAB format, where each of A and B |
| | indicates a phrase having a different form) |
| Asymmetric | Technique usable for a section including |
| | an odd number of phrases (implementable |
| | in ABAA format, where each of A and B |
| | indicates a phrase having a different form) |

The processor 420 may combine the sections generated through section building to generate melody data. While the second audio includes absolute pitch values of the main melody, which may include information such as do, mi, or sol, corresponding to the drawing input of the user, the melody data may include relative pitch values of the second audio (for example, information indicating that, for a melody with three notes, the second note is two tones higher than the first note, and the third note is four tones higher than the first note).

The melody data may include information regarding relative pitch values constituting the melody data, the start point of sound, the length of sound, the intensity of sound (velocity), tone colors, and sound effects such as the types of sound effects including delay, chorus, reverb, filter, or distortion, the start points of sound effects, coverage, and setting values. Particularly, the sound effects may be generated in consideration of the characteristics of the drawing input as well as the characteristics of the first audio included in the music package. Table 4 below lists the elements used to generate the melody data and their results.

TABLE 4

| Input elements | | Used elements and results |
|---|---|---|
| Features | Drawing y-axis information | Modify the pitch |
| of the | Drawing x-axis information | Modify the tempo of the |
| drawing | | second audio by changing the |
| input | | beat and time |
| | Average drawing velocity | Generate slower-paced music |
| | | by adjusting the delay |
| | | element among sound effects |
| | Maximum drawing velocity | Generate faster-paced music |
| | | by adjusting delay effect and |
| | | feedback among sound effects |
| | Drawing process | Control complexity of melody |
| | complexity | line by adjusting complexity |
| | | of melody line |
| | Drawing intensity | Produce a stereoscopic feeling |
| | | for second audio by adjusting |
| | | dynamics of second audio |
| Features | Hash tag of music package | Match brightness of second |
| of the | (light or dark feeling) | audio with brightness of |
| first audio | | first audio |
| | Hash tag of music package | Apply genre characteristics of |
| | (swing) | first audio to second audio |
| | Hash tag of music package | Set length of second audio to |
| | (song length) | length of first audio |
| | Section selection of music | Apply harmony of first audio |
| | package | to harmony of second audio |

The processor 420 may modify the motif in consideration of the characteristics of the first audio included in the music package as well as the characteristics of the drawing input, and may add a sound effect to the motif in consideration of the characteristics of the first audio included in the music package.

The processor 420 may determine the chord scale of the first audio included in the music package. As described before, the chord scale may refer to a group of candidate chords applicable to the melody data. The processor 420 may use the chord scale information to determine an optimal chord to be applied to the melody data, by determining a chord, among the chords included in the chord scale, corresponding to values of the rhythm such as length, height, and slope included in the melody data. The chord scale information may be included in the music package, but the processor 420 may determine the chord scale information by analyzing the first audio.

More specifically, the processor 420 may determine the chord to be applied to the melody data among the chords of the chord scale and may change relative pitch values contained in the melody data to absolute pitch values. For example, melody data with three notes may have relative information that the second note is two tones higher than the first note and the third note is four tones higher than the first note. The processor 420 may apply the determined chord to the melody data to generate the second audio in which the first note is do, the second note is mi, and the third note is sol.

The electronic device 400 may generate an audio file by combining the second audio generated based on the drawing input with the first audio included in the music package. That is, the first audio may correspond to the accompaniment in the audio file, and the second audio may correspond to the main melody in the audio file. The accompaniment refers to the music that compliments the main melody, or in other words, is included with but secondary to the main melody, in order to enhance the main melody.

In one embodiment, the processor 420 may determine musical instruments matching the melody data among a plurality of musical instruments constituting the first audio included in the music package. The processor 420 may combine the first audio played by the determined musical instruments with the second audio for generating an audio file.

In another embodiment, in the first audio included in the music package, the tracks played by individual musical instruments may be partially modified according to a user selection. The first audio generated by combining the modified tracks may be combined with the generated second audio to generate the audio file.

In another embodiment, the first audio played by the musical instruments selected by the user among plural musical instruments constituting the first audio included in the music package may be combined with the generated second audio to generate the audio file. The audio file may be generated using an extension that the electronic device can support, and may be stored in an editable form, so that another electronic device, such as a digital audio workstation (DAW), can readily edit the audio file.

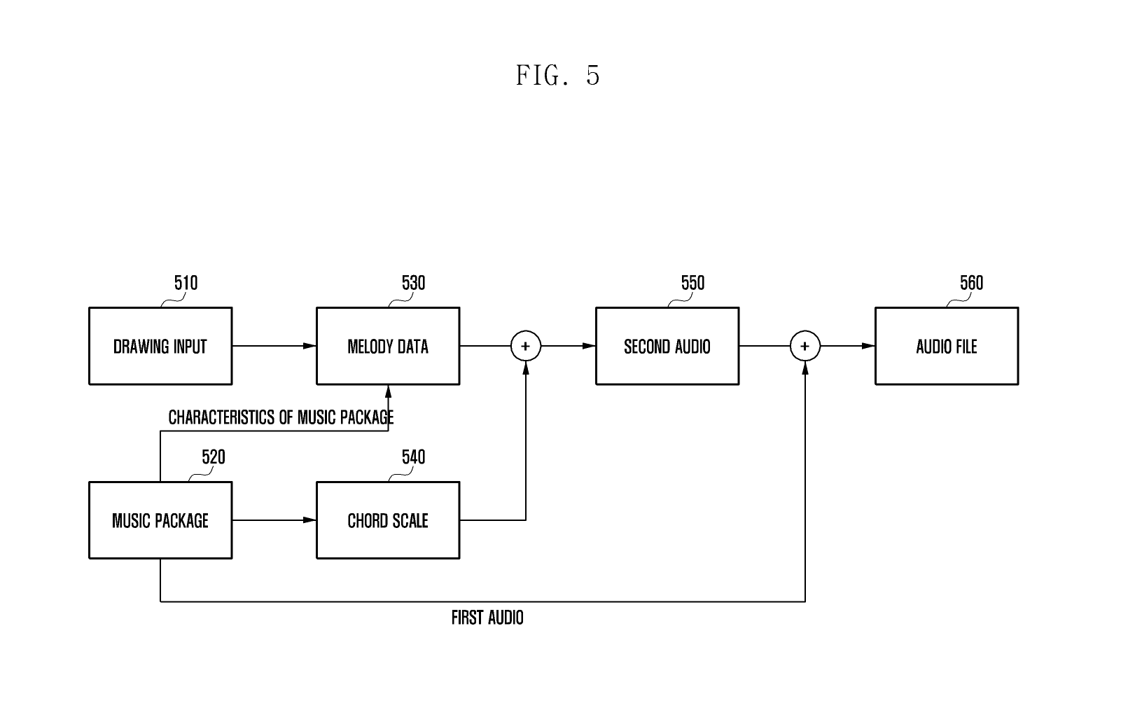

FIG. 5 illustrates a procedure of the electronic device for generating an audio file according to embodiments of the present disclosure.

The processor 420 may generate melody data 530 in consideration of the characteristics of a user gesture input 510 entered by the user on the display 410 and the characteristics of a music package 520 selected by the user.

The processor 420 may combine the chord scale 540, which is a portion of the characteristics of the music package 520 or is generated through analysis of the first audio, with the melody data 530 to produce the second audio 550. In one embodiment, the melody data 530 has relative pitch values of the included notes, and the processor 420 uses the chord scale 540 to convert the relative pitch values of the notes included in the melody data to absolute pitch values.

The processor 420 may combine the generated second audio with the first audio included in the music package to generate the audio file, enabling the user of the electronic device 400 to easily compose a piece of music whose first audio is the music contained in the music package using a user gesture, such as a drawing input.

FIGS. 7A, 7B, 7C, 7D and 7E are screen representations depicting music package selection and editing in the electronic device according to embodiments of the present disclosure. The following description is given under the assumption that a drawing input is received among various examples of the user gesture input.

The electronic device 400 may display a genre selection screen permitting the user to select a desired genre among a plurality of genres on the display 410. FIG. 7A illustrates an example of a genre selection screen. As illustrated in FIG. 7A, a list of music genres, such as hip-hop, rock, K-pop, rhythm and blues (R&B), electronic dance music (EDM), trap, pop, and house, can be displayed on the display 410. Although music genres are presented as circles, there is no limit to the format in which genres are presented. Each genre can be displayed using various shapes such as a square or a triangle according to the designer's decision. An item corresponding to random selection may be displayed inside the genre selection screen. Random selection may indicate selecting any of plural genres supported by the electronic device 400.

For ease of description, the following description is given under the assumption that the user has selected the “rock” genre.

In response to a genre selection, the display 410 may display an attribute selection screen containing tags corresponding to the selected genre as illustrated in FIG. 7B. FIG. 7B illustrates various tags 712-a to 712-f and 713-a to 713-f corresponding to the selected genre 711 (rock). The tag may be a word representing the attribute of the first audio included in the music package. Various attributes of the first audio can be set in advance at the time of music package production. In one embodiment, the processor 420 may identify the tags assigned to each of the music packages stored in the memory, and display the identified tags on the attribute selection screen. In another embodiment, the processor 420 may identify the tags received from a server providing music packages and display the identified tags on the attribute selection screen.

For example, Table 5 below illustrates an embodiment of genres and associated tags.

| Genres | Tags |
|---|---|
| EDM | Energetic |
| | Emotional |
| | Drama |
| | Fresh |
| | Fun |
| | Sad |
| | Sentimental |
| | Tension |
| | Mystery |
| | Fantasy |
| | Chic |
| | Powerful |
| | Magnificent |
| | Dark |
| | White |
| | Musical |
| | Season |
| | Dancy |
| | Generation |
| Rock | K-POP |
| | ENERGETIC |
| | SHORT |
| | BEAT DELAY GUITAR |
| | STRING |
| | VIVID |
| | CALM |
| | BRIGHT ELECTRONIC |
| | DRUM |
| | 70'S ROCK |
| | GROOVE |

Although some genres and tags corresponding to the genres are listed in Table 5, the present disclosure is not limited thereto. The present disclosure may utilize a variety of genres, sub-genres, tags, and sub-tags. In FIG. 7B, various tags corresponding to the rock genre selected by the user are presented as circles. There is no limit to the format in which tags are presented. As illustrated in FIG. 7B, each tag can be displayed inside a circle, but each tag can also be displayed using various shapes such as a square and a triangle.

In one embodiment, the attribute selection screen may include only the second tags related to the attributes excluding the first tag corresponding to the genre. Whether the first tag is displayed may be determined depending on whether the number of the first tag and second tags exceeds the maximum number of tags that the display 410 can present.

The processor 420 may identify the number of second tags corresponding to the attributes associated with the selected genre. If the number of second tags exceeds the maximum number of tags that the display 410 can present, the processor 420 may determine the second tags to be displayed considering the weight of each of the attributes.

The attribute selection screen may include the first tag 711 corresponding to the selected genre and at least one second tag corresponding to the attributes associated with the selected genre (712-a, 712-b, 712-c, 712-d, 712-e, 712-f, 713-a, 713-b, 713-c, 713-d, 713-e, 713-f). To determine the locations where the second tags are to be displayed, the processor 420 may consider the weights of the attributes corresponding to the second tags. For example, among the attributes, those attributes representing sub-genres (when the house genre is selected, Dutch-house or French-house may be a sub-genre) and those attributes associated with musical instruments constituting the first audio included in the music package, such as guitar or bass, may have a higher priority than other attributes, such as lightness or darkness of the music, as previously discussed. For example, in FIG. 7B, the second tags 712-a, 712-b, 712-c, 712-d, 712-e and 712-f arranged in the first region 712 may have a greater weight than the second tags 713-a, 713-b, 713-c, 713-d, 713-e and 713-f arranged in the second region 713.

High priority attributes may have a higher weight than low priority attributes. The processor 420 may compare the weights corresponding to the attributes and determine where the second tags are to be placed. Assuming that the first tag 711 is arranged at the central portion of the attribute selection screen, the high-priority (or high-weight) second tags 712-a, 712-b, 712-c, 712-d, 712-e and 712-f may be arranged in the first region 712 and other second tags 713-a, 713-b, 713-c, 713-d, 713-e, and 713-f may be arranged in the second region 713. It can be seen that the distance between one of the tags included in the first area 712 and the first tag 711 is less than the distance between one of the tags included in the second area 713 and the first tag 711. In one embodiment, the processor 420 may generate the attribute selection screen by placing the tag corresponding to a high-weight attribute closer to the tag corresponding to the genre as compared to the tag corresponding to a low-weight attribute. The distance between the first tag and the second tag may be defined as the distance between the central point of the first tag and the central point of the second tag.

When the user selects a tag “beat delay” 712-b while the attribute selection screen is displayed on the display 410, the processor 420 may display a list of music packages corresponding to the selected genre 711 (rock) and the selected tag 712-b on the display 410. FIG. 7C illustrates a list 715 of music packages corresponding to the selected genre 711 and the selected tag 712-b. In another embodiment, to add a music package that is not present in the memory of the electronic device 400, when the user selects a separate button 716, the processor 420 may control the communication module to download the music package corresponding to the selected genre 711 and the selected tag 712 from a server. The user may additionally select a tag, and may also select the tag 712-d (electronic music) and the tag 712-e (guitar) as illustrated in FIG. 7C. The processor 420 may identify the music packages corresponding to the genre 711 and the selected tags 712-b, 712-d and 712-e, and control the display 410 to display a list of music packages corresponding to the genre 711 and the selected tags 712-b, 712-d and 712-e. FIG. 7C illustrates a music package list 715 corresponding to the genre 711 and the selected tags 712-b, 712-d and 712-e. As described above, the electronic device 400 can readily provide the user with a music package usable for composition.

FIG. 7D illustrates a detailed screen of a music package selected from among the music packages corresponding to the genre 711 and the selected tags 712-b, 712-d and 712-e. As illustrated in FIG. 7D, the detailed screen of the music package may include a preview button 721, detailed information 722 and 723 of the music package, and a user gesture input button 724 for melody generation. In response to an input on the preview button 721, the processor 420 may control the speaker to reproduce the first audio included in the selected music package. The detailed information of the music package may include a field 722 for the song title and the number of bits of the first audio included in the music package, and a field 723 for information on the musical instruments constituting the first audio. In response to a user input on the user gesture input button 724, the processor 420 may control the display 410 to display a user gesture input screen.

The processor 420 may filter the music package corresponding to the genre and tag selected by the user (the music package may be stored in the electronic device 400 or provided by a server).

The selected tag may be used for generation of the second audio. The processor 420 may modify the motif in consideration of the characteristics of the selected tags, as described above in relation to Table 4. For example, if the feature of the selected tag is associated with Swing (i.e., a genre of jazz popularized in the 1920's to mid-1940's) feature of the variation, the processor 420 may modify the generated melody data by applying a swing effect to the generated melody data. In addition, the processor 420 may modify the first audio by applying a swing effect to the first audio.

The features or characteristics corresponding to the music package may be pre-stored in the memory of the electronic device 400, such as in a format illustrated in Table 6 below.

TABLE 6

| Length of first audio | Complexity | Variation |
|---|---|---|
| Short (under 1 minute) | Simple | Swing |
| | Every part is of | |
| | complexity ≤3 | |
| Medium (under 4 minutes) | Complicated | Too much swing |
| | Every part is of | |
| | complexity ≥5 | |
| Long (over 4 minutes) | — | Groove |
| | | (Velocity) |
| — | — | Too much groove |
| | | (Velocity) |
| — | — | Drum short |
| — | — | Drum very short |

The processor 420 may generate an audio file using the music package selected by the user as illustrated in FIGS. 7A, 7B, 7C and 7D.

The processor 420 may edit the music package selected by the user and generate an audio file using the edited music package. FIG. 7E illustrates a screen for supporting editing of the first audio included in the music package based on the user selection. As illustrated in FIG. 7E, the first audio edit support screen may include a section selection region 731 for displaying a list of sections of the first audio, a region 732 for displaying a list of sounds selectable in each section, a play button 734, a repeat button 735, a correction button 736, a user gesture input button 737, and a finish button 738. The list of selectable sounds for each section may indicate alternative sounds, which refers to a set of sounds whose chord progression is identical or similar.

Referring to reference numeral 733 of FIG. 7E, the user can select one sound from among alternative sounds A, B, C and D. The processor 420 may edit the first audio using a combination of sounds selected by the user. In response to a user input on the play button 734, the processor 420 may control the speaker to reproduce the first audio. In response to a user input on the repeat button 735, the processor 420 may control the speaker to reproduce the first audio repeatedly. In response to a user input on the correction button 736, the processor 420 may modify (add or delete) the selected section in the section selection region.

In response to an additional user input on the drawing input button 737, the processor 420 may control the display 410 to display a screen for supporting separate drawing input to the selected section. The additional drawing input may indicate generating an independent second audio for each of the sections constituting the music. For example, the drawing input used for the chorus and the drawing input used for the introduction can be made different from each other to generate second audio versions separately used for the chorus and the introduction. For example, in response to a user input on the user gesture input button 737, the processor 420 may control the display 410 to display a user gesture input screen for the section selected in the section selection region, and may generate a second audio to be applied to the selected section in response to the user gesture input entered by the user.

After selecting the music package, the processor 420 may control the display 410 to display a screen for receiving a user drawing input. FIG. 6A illustrates a screen capable of supporting a user drawing input. In FIG. 6A, the x-axis of the drawing input support screen may indicate the beats and bars included in the motif, and the y-axis may indicate the pitch of the motif.

In response to a user input on the first audio edit button 617, the processor 420 may control the display 410 to display the screen illustrated in FIG. 7E. In response to a user input on the play button 618, the processor 420 may control the speaker to reproduce the second audio. In response to a user input on the repeat button 619, the processor 420 may control the speaker to reproduce the second audio repeatedly. In response to a user input on the play/non-play selection button 620 for the first audio, the processor 420 may control the speaker to reproduce the first audio corresponding to the second audio.

According to various embodiments of the disclosure, an electronic device includes a display, and a processor configured to control the display to display a genre selection screen for selecting one or more genres of music, control, in response to a user input for selecting one of the one or more genres, the display to display an attribute selection screen for selecting attributes corresponding to the selected genre, control the display to display a list of music packages corresponding to the selected genre and selected attribute, and generate, in response to a user input for selecting one of the music packages included in the list, an audio file by combining the first audio corresponding to the selected music package with the second audio generated based on a user gesture input.

The attribute selection screen may include a first tag corresponding to the selected genre and at least one second tag corresponding to attributes associated with the selected genre, and the processor may be configured to determine the position of the second tag on the attribute selection screen in consideration of the weight of each of the attributes.

The processor may be configured to place the first tag at the central portion of the attribute selection screen, determine the distance between the second tag and the first tag in consideration of the weight of the attribute corresponding to the second tag, and place the second tag on the attribute selection screen based on the determined distance.

The higher the weight of the attribute corresponding to the second tag, the shorter the distance between the second tag and the first tag.

If the number of second tags exceeds a preset value, the processor may determine the second tags to be displayed in consideration of the weight of each of the attributes.

The processor may be configured to edit the first audio based on the at least one selected attribute, determine a sound effect to be applied to the second audio based on the at least one selected attribute, and generate the audio file by combining the edited first audio with the second audio.

In response to a user input for selecting one of the music packages included in the list, the processor may be configured to control the display to display a user gesture input screen for receiving a user gesture input.

The processor may be configured to generate melody data based on the characteristics of the first audio included in the selected music package and the characteristics of the user gesture input, determine at least one chord to be applied to the melody data based on chord information included in the selected music package, and generate the second audio by applying the determined chord to the melody data.

The processor may be configured to control the display to display a screen for selecting one of plural sounds that are applicable to at least one of the sections constituting the music, and edit second audio data in response to a user input for selecting one of the plural sounds.

The processor may be configured to control the display to display a music package recommendation screen corresponding to the selected genre and the characteristics of the selected genre, and control, in response to a user input for selecting a music package from the music package recommendation screen, the display to display a screen for downloading the selected music package.

According to another embodiment of the present disclosure, an electronic device includes a display, and a processor configured to control the display to display a genre selection screen for selecting one or more genres of music, control, in response to a user input for selecting one of the one or more genres, the display to display an attribute selection screen for selecting attributes corresponding to the selected genre, control the display to display a list of music packages corresponding to the selected genre and selected attribute, and control, in response to a user input for selecting one of the music packages included in the list, reproduction of the first audio corresponding to the selected music package.

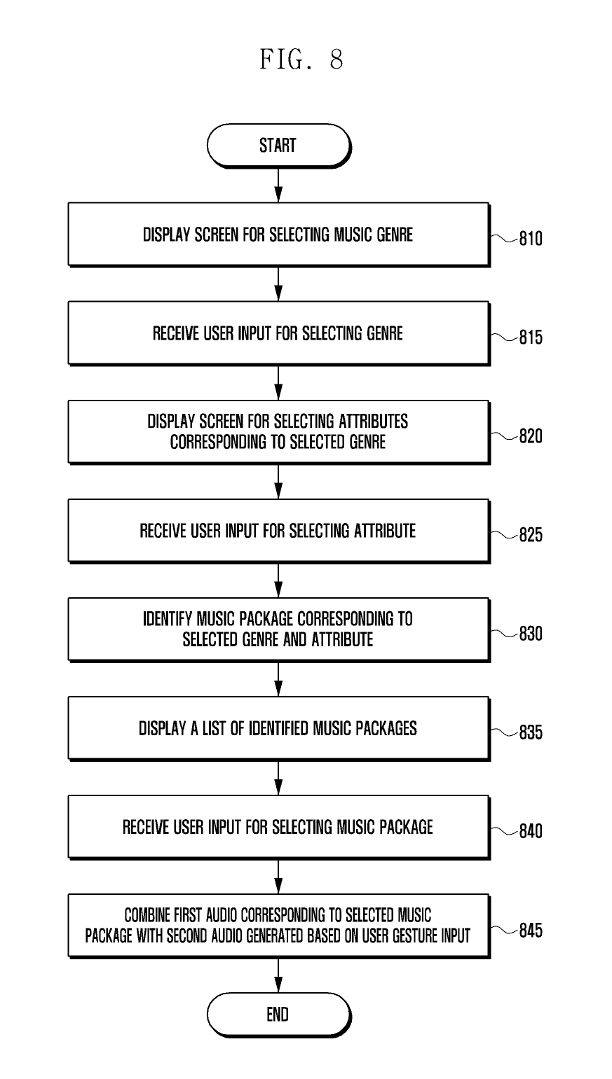

FIG. 8 is a flowchart illustrating a method of the electronic device according to embodiments of the present disclosure.

The processor 420 may control the display 410 to display a genre selection screen for selecting one or more genres of music in step 810.

Upon receiving a user input for selecting one of the genres in step 815, the processor 420 may control the display 410 to display an attribute selection screen for selecting attributes corresponding to the selected genre in step 820.

Upon receiving a user input for selecting an attribute from the attribute selection screen in step 825, the processor 420 may identify music packages corresponding to the selected genre and selected attribute in step 830.

The processor 420 may display a list of the identified music packages on the display 410 in step 835.

Upon receiving a user input for selecting a music package from the list in step 840, the processor 420 may generate an audio file by combining the first audio corresponding to the selected music package with the second audio generated based on a user gesture input in step 845.

Generation of the second audio is described with reference to FIGS. 4 and 5.

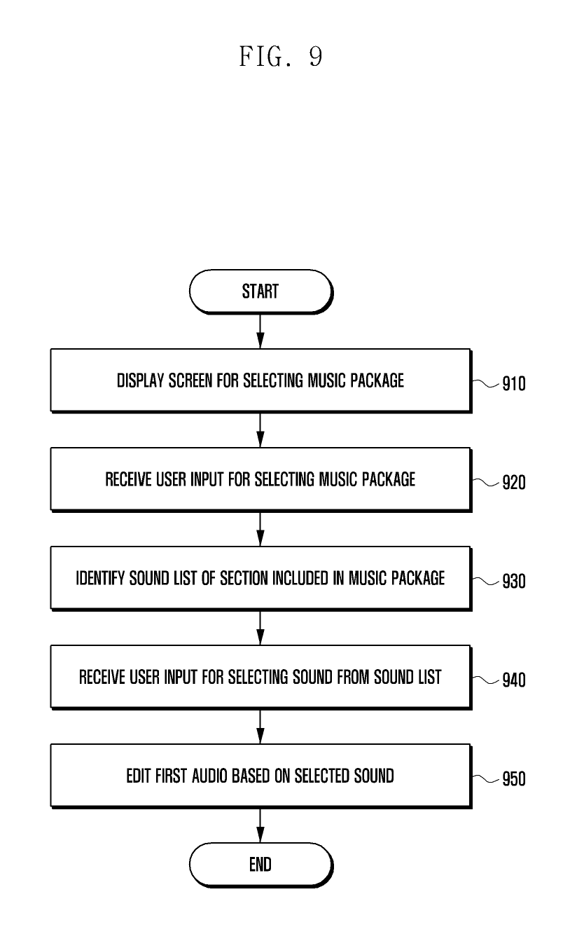

FIG. 9 is a flowchart illustrating editing the first audio in the method of the electronic device according to embodiments of the present disclosure.

The description on the procedure of FIG. 9 may include a description on generating the first audio not equal to the first audio included in the music package.

The processor 420 may control the display 410 to display a screen for selecting a music package in step 910, and may receive a user input for selecting a music package in step 920.

The processor 420 may identify a list of sounds available in each section included in the first audio of the music package in step 930. The list of sounds available in each section may be displayed on the display 410 as illustrated in FIG. 7E. The processor 420 may receive a user input for selecting a sound from the sound list in step 940.

The processor 420 may edit the first audio in response to the user input and generate an audio file corresponding to the first audio in step 950. The audio file generated at step 950 may be combined with the second audio generated by the processor 420 based on a user gesture input and may be used to generate the final audio file (composition file).

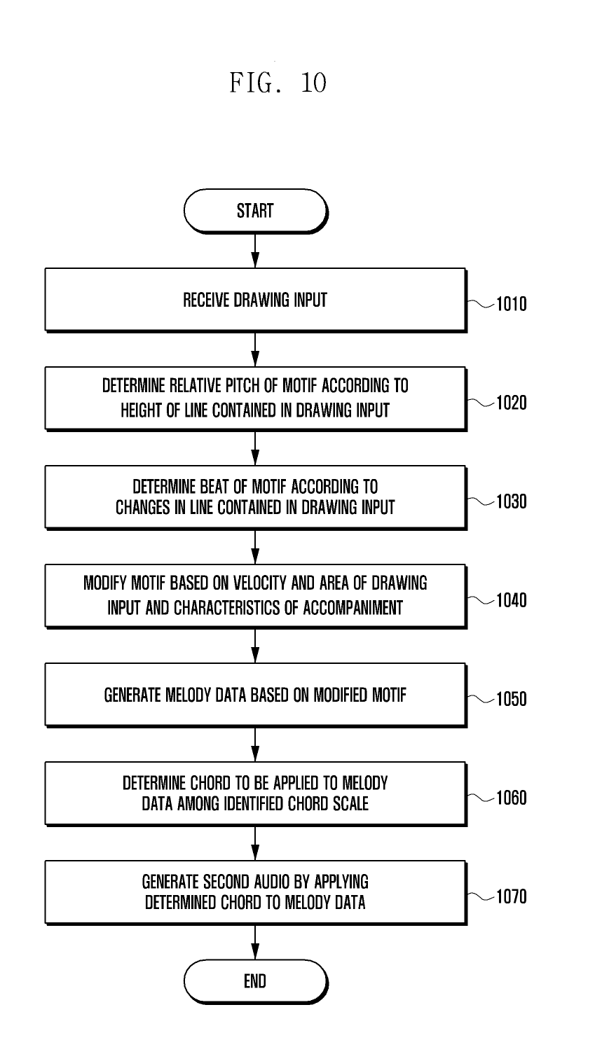

FIG. 10 is a flowchart illustrating generating the second audio based on user gesture input in the method of the electronic device according to embodiments of the present disclosure.

The processor 420 may receive a user gesture input entered on the display 410 in step 1010.

The user gesture input may include a drawing input. The processor 420 may identify the characteristics of the user gesture input using the four layers, which may include a canvas, motif, history, and area layer. The canvas layer may store information on the drawings contained in the user gesture input. The motif layer may store information on the order in which drawings are input by the user gesture input and the position of each drawing drawn on the canvas layer. The history layer may store information regarding the order in which the lines included in each drawing are drawn, the speed at which each line is drawn, the position of each line drawn on the canvas layer, and the process by which each drawing is created. The area layer may store information regarding the area of the canvas layer occupied by each drawing included in the user gesture input, and point (or area) created by the intersection of the drawings included in the user gesture input. While receiving a user gesture input from the user, the processor 420 may generate the four layers and identify the characteristics of the user gesture input using the four layers. The processor 420 may modify the generated motif based on the characteristics of the user gesture input.

The processor 420 may determine the relative pitch of the motif according to the height of the line contained in the user gesture input in step 1020.

The processor 420 may determine the rhythm or beat of the motif according to changes in the line contained in the user gesture input in step 1030.

The processor 420 may modify the motif based on the velocity and area of the user gesture input and the characteristics of the first audio (or accompaniment) in step 1040.

The processor 420 may generate melody data by using the modified motif and sound effects corresponding to the characteristics of the first audio in step 1050.

The processor 420 may identify the chord scale included in the characteristics of the first audio and determine the chord corresponding to the melody data among the chords in the chord scale in step 1060.

The processor 420 may generate the second audio by applying the determined chord to the melody data in step 1070. The generated second audio may be combined with the first audio for generating an audio file. This audio file may correspond to a completed piece of music composed by the user.

According to various embodiments of the present disclosure, a method for an electronic device includes displaying a genre selection screen for selecting one or more genres of music; displaying, in response to a user input for selecting one of the genres, an attribute selection screen for selecting attributes corresponding to the selected genre; identifying at least one attribute selected by the user from the displayed attributes; displaying a list of music packages corresponding to the selected genre and selected attribute; and generating, in response to a user input for selecting one of the music packages included in the list, an audio file by combining the first audio corresponding to the selected music package with the second audio generated based on the user gesture input.

The attribute selection screen may include a first tag corresponding to the selected genre and at least one second tag corresponding to attributes associated with the selected genre, and the position of the second tag on the attribute selection screen may be determined in consideration of the weight of each of the attributes.

The first tag may be placed at the central portion of the attribute selection screen.

The method may further include determining the distance between the second tag and the first tag in consideration of the weight of the attribute corresponding to the second tag, and placing the second tag on the attribute selection screen based on the determined distance.

The second tag may be placed such that the distance between the second tag and the first tag decreases as the weight of the attribute corresponding to the second tag increases.

The method may further include determining, if the number of second tags exceeds a preset value, the attributes to be displayed in consideration of the weight of each of the attributes, editing the first audio based on the at least one selected attribute, and displaying, in response to a user input for selecting one of the music packages included in the list, a user gesture input screen for receiving a user gesture input.

Generating an audio file may include generating melody data based on the characteristics of the first audio included in the selected music package and the characteristics of the user gesture input, determining at least one chord to be applied to the melody data based on chord information included in the selected music package, and generating the second audio by applying the determined chord to the melody data.

The method above is described with reference to flowcharts, methods, and computer program products according to embodiments of the present disclosure, each of which being implementable by computer program instructions provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

The computer program instructions may also be stored in a computer usable or computer-readable memory that can direct a computer or other programmable data processing apparatus to function in a particular manner, such that the instructions produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions provide operations for implementing the functions specified in the flowchart block or blocks.

Each block of the flowcharts may represent a module, a segment, or a portion of code, which includes one or more executable instructions for implementing the specified logical function(s). It should also be noted that in some alternative implementations, the functions noted in the blocks may occur out of order. For example, two blocks illustrated in succession may, in fact, be executed substantially concurrently or the blocks may sometimes be executed in the reverse order, depending upon the functionality involved.

Certain aspects of the present disclosure may also be embodied as computer readable code on a non-transitory computer readable recording medium, which is any data storage device that may store data which may be thereafter read by a computer system. Examples of a non-transitory computer readable recording medium include a read-only memory (ROM), a random access memory (RAM), compact disc-ROMs (CD-ROMs), magnetic tapes, floppy disks, and optical data storage devices. A non-transitory computer readable recording medium may also be distributed over network coupled computer systems so that computer readable code is stored and executed in a distributed fashion. In addition, functional programs, code, and code segments for accomplishing the present disclosure may be easily construed by programmers skilled in the art to which the present disclosure pertains.

Embodiments of the present disclosure may involve the processing of input data and the generation of output data to some extent, and may be implemented in hardware or software in combination with hardware. For example, certain electronic components may be employed in a mobile device or similar or related circuitry for implementing the functions associated with the embodiments of the present disclosure. Alternatively, one or more processors operating in accordance with stored instructions may implement the functions associated with the embodiments of the present disclosure. If such is the case, it is within the scope of the present disclosure that such instructions may be stored on one or more non-transitory processor readable mediums.

Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure may be easily construed by programmers skilled in the art to which the present disclosure pertains.

Embodiments of the present disclosure may be implemented in hardware, firmware or via the execution of software or computer code that may be stored in a recording medium, such as a CD ROM, a DVD, a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods of the present disclosure may be rendered via such software that is stored on the recording medium using a general purpose computer, or a special processor or in programmable or dedicated hardware, such as an ASIC or an FPGA.

As would be understood by those skilled in the art, a computer, a processor, a microprocessor controller or programmable hardware include memory components that may store or receive software or computer code that when accessed and executed by the computer, the processor or the hardware implement the methods of the present disclosure.

While the present disclosure has been illustrated and described with reference to various embodiments thereof, it will be understood by those skilled in the art that various changes in form and details may be made therein without departing from the scope of the present disclosure as defined by the appended claims and their equivalents.

What is claimed is:

1. An electronic device capable of generating an audio file, the electronic device comprising:
a display; and
a processor configured to:
control the display to display a genre selection screen from which one or more genres of music is selected,
control, in response to a user input for selecting at least one of the genres, the display to display an attribute selection screen from which attributes corresponding to the selected genre are selected,
control the display to display a list of music packages corresponding to the selected genre and selected attribute, and
generate, in response to a user input for selecting one of the music packages included in the list, the audio file by combining first audio corresponding to the selected music package with second audio generated based on a user gesture input.

2. The electronic device of claim 1,
wherein the attribute selection screen includes a first tag corresponding to the selected genre and at least one second tag corresponding to attributes associated with the selected genre, and
wherein the processor is further configured to determine a position of the second tag on the attribute selection screen in consideration of a weight of each of the attributes.

3. The electronic device of claim 2, wherein the processor is further configured to place the first tag at a central portion of the attribute selection screen, determine a distance between the second tag and the first tag in consideration of the weight of the attribute corresponding to the second tag, and place the second tag on the attribute selection screen based on the determined distance.

4. The electronic device of claim 3, wherein the second tag is placed such that the distance between the second tag and the first tag decreases as the weight of the attribute corresponding to the second tag increases.

5. The electronic device of claim 2, wherein, if the number of second tags exceeds a preset value, the processor is further configured to determine the second tags to be displayed in consideration of the weight of each of the attributes.

6. The electronic device of claim 1, wherein the processor is further configured to edit the first audio based on the at least one selected attribute.

7. The electronic device of claim 6, wherein the processor is further configured to determine a sound effect to be applied to the second audio based on the at least one selected attribute.

8. The electronic device of claim 6, wherein the processor is further configured to generate the audio file by combining the edited first audio with the second audio.

9. The electronic device of claim 1, wherein, in response to a user input for selecting one of the music packages included in the list, the processor is further configured to control the display to display a user gesture input screen for receiving a user gesture input.

10. The electronic device of claim 1, wherein the processor is further configured to:
generate melody data based on characteristics of the first audio included in the selected music package and characteristics of the user gesture input,
determine at least one chord to be applied to the melody data based on chord information included in the selected music package, and
generate the second audio by applying the determined chord to the melody data.

11. The electronic device of claim 1, wherein the processor is further configured to control the display to:
display a screen for selecting one of plural sounds that are applicable to at least one of the sections constituting the music, and
edit second audio data in response to a user input for selecting one of the plural sounds.

12. The electronic device of claim 1, wherein the processor is further configured to control the display to:
display a music package recommendation screen corresponding to the selected genre and the characteristics of the selected genre, and
display, in response to a user input for selecting one of music packages included in the music package recommendation screen, a screen for downloading the selected music package.

13. A method for operating an electronic device, the method comprising:
displaying a genre selection screen from which one or more genres of music is selected;
displaying, in response to a user input for selecting at least one of the genres, an attribute selection screen from which attributes corresponding to the selected genre are selected;
identifying at least one attribute selected by a user from the displayed attributes;
displaying a list of music packages corresponding to the selected genre and selected attribute; and
generating, in response to a user input for selecting one of the music packages included in the list, an audio file by combining first audio corresponding to the selected music package with second audio generated based on the user gesture input.

14. The method of claim 13,
wherein the attribute selection screen includes a first tag corresponding to the selected genre and at least one second tag corresponding to attributes associated with the selected genre, and
wherein a position of the second tag on the attribute selection screen is determined in consideration of a weight of each of the attributes.

15. The method of claim 14, further comprising:
determining a distance between the second tag and the first tag in consideration of the weight of the attribute corresponding to the second tag; and
placing the second tag on the attribute selection screen based on the determined distance,
wherein the first tag is placed at a central portion of the attribute selection screen.

16. The method of claim 14, wherein the second tag is placed such that a distance between the second tag and the first tag decreases as the weight of the attribute corresponding to the second tag increases.

17. The method of claim 14, further comprising determining, if the number of second tags exceeds a preset value, the attributes to be displayed in consideration of the weight of each of the attributes.

18. The method of claim 13, further comprising editing the first audio based on the at least one selected attribute.

19. The method of claim 13, further comprising displaying, in response to a user input for selecting one of the music packages included in the list, a user gesture input screen for receiving a user gesture input.

20. The method of claim 13, wherein generating the audio file comprises:
generating melody data based on characteristics of the first audio included in the selected music package and characteristics of the user gesture input;
determining at least one chord to be applied to the melody data based on chord information included in the selected music package; and
generating the second audio by applying the determined chord to the melody data.

21. An electronic device comprising:
a display; and
a processor configured to:
control the display to display a genre selection screen from which one or more genres of music is selected,
control, in response to a user input for selecting at least one of the genres, the display to display an attribute selection screen from which attributes corresponding to the selected genre are selected,
control the display to display a list of music packages corresponding to the selected genre and selected attribute, and
control, in response to a user input for selecting one of the music packages included in the list, reproduction of first audio corresponding to the selected music package.
